(19) United States
(12) Patent Application Publication
(10) Pub. No.: US 2003/0211265 A1
(43) Pub. Date: Nov. 13, 2003

(54) Tube product with molded on bracket

(76) Inventors: Jonathon Balbaugh, Ottawa, OH (US); Randal Teders, Findlay, OH (US)

Correspondence Address: CARLSON, GASKEY & OLDS, P.C., 400 WEST MAPLE ROAD, SUITE 350, BIRMINGHAM, MI, 48009, US

(21) Appl. No.: 10/149,490

(22) PCT Filed: Dec. 13, 2000
(86) PCT No.: PCT/US00/33731

(51) Int. Cl. B29C 43/18; B29C 45/14; B32B 1/08

(52) U.S. Cl. 428/36.9; 264/274

(57) ABSTRACT

A relatively simple assemblage according to the invention includes a uniquely shaped length of tubing (10) and a bracket (12) which has a mounting pad (14) and a band section (15) which is molded about tubing (10) at a predetermined location. The method of making the assemblage includes providing one or more lengths of tubing (10) which are formed to a desired shape, and a plastic molding material which shrinks by a determinable amount on cooling (e.g. a retractable polyamide material). Using a mold, the plastic molding material is molded to and/or about a predetermined area of the tubing (10), thus gripping the exterior of the tubing at a predetermined orientation, as determined by the positioning of the length of tubing (10) in the mold, and thus forming the molded addition.

### BACKGROUND OF THE INVENTION

The invention relates to a tube product, e.g. a uniquely shaped assemblage of one or more sections of tubing with one or more molded-in-place brackets fitted thereto and providing one or more mounting points for the assemblage. It is becoming more commonplace in automotive and similar manufacturing industries to use subassemblies of uniquely shaped tubing, with their mounting brackets attached and holding the tube or tubes of the subassembly in a desired orientation which is dictated by the ultimate connection of the tube(s) of the subassembly into a part of a larger unit, for example such as a vehicle engine, or air conditioning unit, or fuel system.

These subassemblies are provided to a station along an assembly line and can readily be fitted and connected to other parts, and mounted to those parts or to a common enclosure such as an engine compartment in an automotive vehicle. Various schemes have been used to keep the tubing of the subassembly in its proper orientation while it is being fastened in place. This may be important from the standpoint of an awkward access to a mounting point(s), or a need to keep constant the relative positions of multiple tubes in a subassembly.

### SUMMARY OF THE INVENTION

In a typical simple example, one or more lengths of tubing are formed to a desired shape or route, and a plastic molding material which shrinks by a determinable amount (e.g. 1%) on cooling, such as a retractable polyamide material, is molded to and/or about a predetermined area of the tubing and thus grips the exterior of the tubing at a predetermined orientation, as determined by the positioning of the tubing length(s) in a mold. The molded addition to the tubing may be a joining article which maintains relative orientation of multiple tube lengths, and/or may include a mounting bracket for the resultant unique article. If the contact area of the bracket to tubing is small, the outer tube surface may be knurled or roughened if the shrinkage of the plastic is insufficient to achieve the necessary non-movable joint between tube and bracket.

The bracket, once molded, adheres to the tubing in a predetermined orientation, to assure that the bracket does not rotate about the tubing and is essentially immovable with respect to that tubing. In many instances this additional roughening or knurling preparation step on the tubing surface is unnecessary, in which instances the tubing can be taken to the bracket molding process without any preparation of tubing surfaces.

Furthermore, an attachment or mounting pad on the bracket (if used) is oriented with respect to the tubing shape as a result of this molding addition, so as to be properly located for ease of fit and mounting when the unique article, a subassembly of tube and bracket, is placed in its intended location by an assembler.

In more complex examples, a pair or more of irregularly shaped tubes may be joined by the material of the bracket (or plural brackets), thus serving to maintain a particular alignment of the several tubes as well as providing a mounting of the assemblage.

Other objects and advantages of the invention will be apparent from the following description, the accompanying drawings and the appended claims.

### BRIEF DESCRIPTION OF THE DRAWINGS

FIG. 1 is a perspective view of a first exemplary embodiment of the invention illustrating a single shaped tube and attached mounting bracket;

FIG. 2 is a perspective view of a second exemplary embodiment of the invention illustrating multiple shaped tubes and attached mounting bracket and retaining bracket;

FIG. 3 is an enlarged view illustrating the overloud material without the tubes;

FIG. 4 is a plan view of an upper die for forming a retaining bracket;

FIG. 5 is a plan view of a lower die for forming a retaining bracket;

FIG. 6 comprises side views of the upper and lower dies shown in FIGS. 4 & 5; and

FIG. 7 is a perspective view of upper and lower dies, in open position, for forming a mounting bracket.

### DESCRIPTION OF PREFERRED EMBODIMENTS

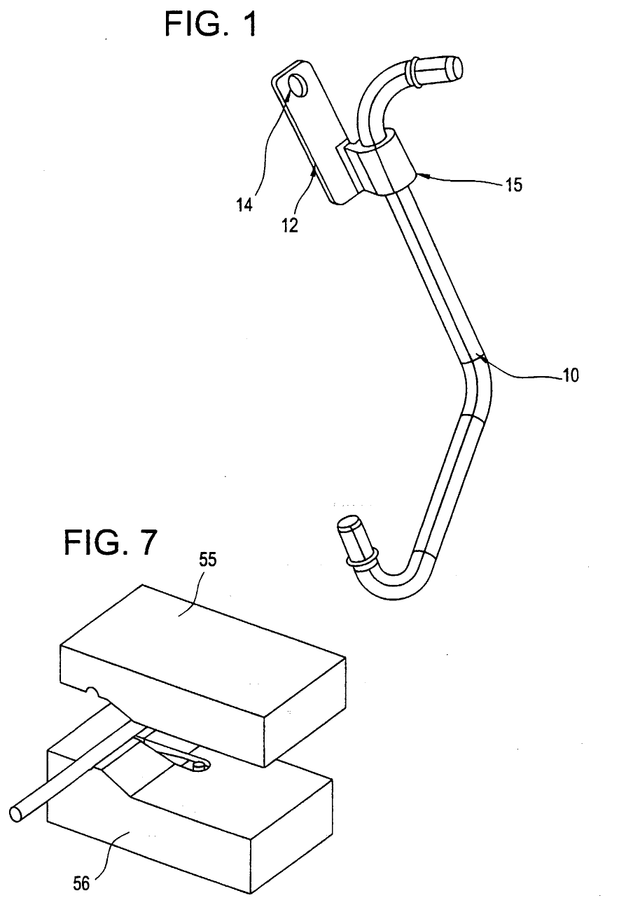

Referring to FIG. 1, a relatively simple assemblage according to the invention includes a uniquely shaped length of tubing 10 and a bracket 12 which has a mounting pad 14 and a band section 15 which is molded about tubing 10 at a predetermined location. The tubing 10 can be made of various materials, such a shaped rubber hose, metal pipe, plastic tubing, or a composite rubber/plastic hose. The shape of the tube will vary with each design of assemblage, as will the location of the bracket band section 15 on tubing 10.

The material of the bracket is chosen from any thermoset or thermoplastic material which shrinks (or retracts) in a predetermined manner, or of a moldable metal having those characteristics, so long as the material chosen is compatible to the material of the tubing which it surrounds, and the molding bracket addition process does not affect the integrity of the tubing.

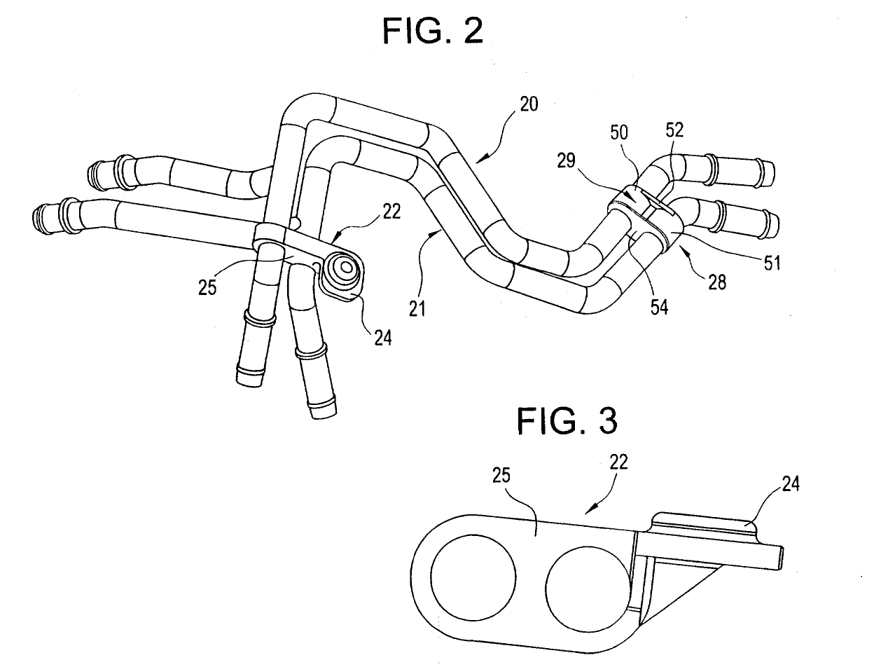

FIG. 2 illustrates a more complex subassembly according to the invention including uniquely shaped lengths of tubing 20 and 21 and two brackets. A first or mounting bracket 22 has a mounting pad 24 and a band section 25 which is molded about tubing 20 and 21 at a predetermined location on each of the length of tubing. The second or retaining bracket 28 has only a band section 29 which is molded about tubing 20 and 21 at another location, and serves only the function of maintaining relative position of the two tubes. Again, the tubing 20 and 21 can be made of various materials, such a shaped rubber hose, metal pipe, plastic tubing, or a composite rubber/plastic hose. The shape of the tubes will vary with each design of assemblage, as will the location of the bracket band section on tubing 20 and/or 21.

FIG. 3 illustrates one form of connection between the bracket band and the tubing(s); in this case the bracket 22 (FIG. 2) is a molded-in-place integral member which includes band section 25 and mounting pad 24. During the bracket addition molding step, when the material cools and hardens (sets up), it shrinks and thus tightens about the surrounded portion of tubing(s) and the bracket thus is interlocked to prevent relative rotation of the tubing and bracket. If the tubing is of a relatively small diameter, for example one-half inch, the exterior of the tubing at the point of molding the bracket can be knurled or roughened so as to provide minute interstices in the tube surface, into which the molten material may extend to provide the requisite anti-rotation feature.

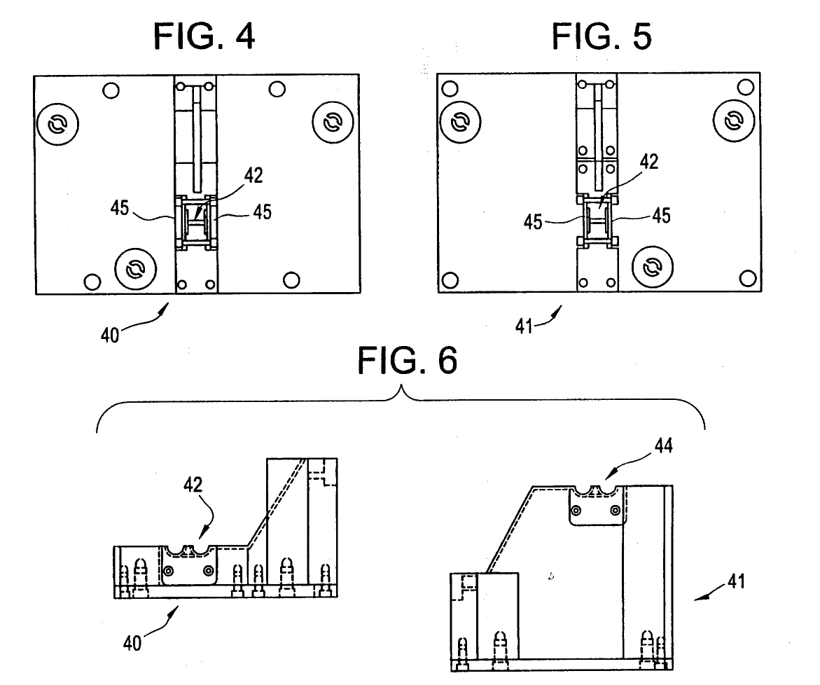

FIGS. 4, 5 & 6 illustrate a typical set of molds 40, 41 which can be used, for example, in a plastic injection molding machine, and which include upper and lower mold cavities 42, 44 shaped to form a retaining bracket 28. Passages 45 at either side of the mold cavities 42, 44 admit the tubing and locate it within the mold as it closes about the tubing, thus defining the exterior shape, dimensions, and orientation of the bracket. Molten plastic is injected into the mold cavities to form the bracket which, in this example, includes band sections 50, 51 formed on and around the tubing, and connecting web sections 52, 54 which join the band sections (FIG. 2).

FIG. 6 illustrates upper and lower molds 55, 56, in open position, which cooperate to define and form a mounting bracket, such as bracket 22 (FIG. 2).

While the method herein described, the article formed thereby, and the forms of apparatus for carrying this method into effect, constitute preferred embodiments of this invention, it is to be understood that the invention is not limited to these precise method, articles, and apparatus, and that changes may be made in either without departing from the scope of the invention, which is defined in the appended claims.

What is claimed is:

1. A method of forming unique tubing articles, comprising the steps of:
a) forming at least one more length of tubing to a desired shape,
b) placing such length of tubing in a mold having at least one cavity surrounding a predetermined area of such tubing,
c) filling the mold cavity with a plastic molding material which shrinks upon cooling by a determinable amount, and
d) allowing the molding material to cool and harden, thereby joining a molded shape to the predetermined area of the tubing at a predetermined orientation.

2. A method as defined in claim 1, wherein the at least one length of tubing is configured into a predetermined route, and the molded shape is configured as a mounting bracket having a predetermined orientation to said tubing.

3. A method as defined in claim 1, wherein the predetermined area of the at least one length of tubing has a roughened surface to enhance non-rotational bonding of the molded shapes to the tubing.

4. A method as defined in claim 1, wherein
step (a) includes forming at least two lengths of tubing into related steps,
step (b) includes placing predetermined areas of each of said two lengths into the mold cavity with the lengths in predetermined orientation, and
step (c) includes joining of the at least two lengths of tubing at the resultant molded shape in a relationship determined by positioning of the tubing lengths in the mold.

5. The method defined in claim 4, wherein
step (b) includes holding the lengths of tubing in predetermined relationship, and
(e) forming the molded shape into a mounting bracket for the at least two lengths of tubing oriented to a placement location for those lengths.

6. An article of tubing shaped in predetermined manner to fit within a similarly shaped location, said article including
at least one shaped length of tubing shaped to fit within the location, and
a molded piece formed on and affixed to a predetermined area of said at least one length of tubing in a predetermined orientation to said at least one length.

7. An article as defined in claim 6, wherein said molded piece includes a bracket formation for mounting the article.

8. An article as defined in claim 6, wherein said molded piece is shaped to provide at least one fixed joint affixed to predetermined areas of at least two of said lengths of tubing to join and maintain said two lengths in relative orientation.

9. An article as defined in claim 8, wherein
two molded pieces are formed in spaced relation to each other at spaced apart locations along said at least two lengths of tubing, and
at least one of said molded pieces also includes a bracket formation for mounting the article.

10. An article made according to the method of claim 1.
